(19) United States
(12) Patent Application Publication
(10) Pub. No.: US 2023/0288872 A1
(43) Pub. Date: Sep. 14, 2023

(54) METHOD FOR MANUFACTURING A MICROMECHANICAL COMPONENT, PARTICULARLY A TIMEPIECE WHEEL, THE SURFACE OF WHICH IS OPTIMISED

(71) Applicant: ETA SA Manufacture Horlogère Suisse, Grenchen (CH)

(72) Inventors: Serge NICOUD, Couvet (CH); Samuel VIGNIER, Saint-Maurice-sous-les-Côtes (FR); Sébastien RODER, Bienne (CH); Jean-Luc HELFER, Le Landeron (CH); Christian CHARBON, Chézard-St-Martin (CH); Frédéric KOHLER, Avry-sur-Matran (CH)

(73) Assignee: ETA SA Manufacture Horlogère Suisse, Grenchen (CH)

(21) Appl. No.: 18/006,672

(22) PCT Filed: Aug. 31, 2021
(86) PCT No.: PCT/EP2021/074027

§ 371 Date: Jan. 24, 2023

(30) Foreign Application Priority Data
Sep. 15, 2020 (EP) 20196228.9

(51) Int. Cl. G04B 15/14; G04B 31/08

(52) U.S. Cl. CPC G04B 15/14; G04B 31/08

(57) ABSTRACT

A method for manufacturing a timepiece wheel, according to which a substrate is produced with a first material including at least nickel and phosphorus, the substrate is shaped to the geometry of the wheel, and a coating of the substrate is performed, galvanically and/or chemically, on at least one surface of the substrate of the wheel, with at least one second material, which constitutes the peripheral layer of the wheel at the at least one surface of the substrate of the wheel, and which includes at least nickel and which is poorer in phosphorus than the first material, or which includes nickel and is devoid of phosphorus.

### FIELD OF THE INVENTION

The invention relates to a method for manufacturing a micromechanical component, particularly a timepiece wheel.

The invention relates to the field of timepiece mechanisms, and more particularly escapement mechanisms including at least one escape wheel and at least one pallet, of which at least one of them is of non-magnetic nature.

### BACKGROUND OF THE INVENTION

In Swiss lever timepiece escapement mechanisms, the Swiss lever escape wheels are historically made of nickel-plated steel, and are sensitive to magnetic fields.

Alternatives are known with materials such as nickel-phosphorus NiP12 implemented by “LIGA” (Lithographie and Galvano-Abformung, meaning lithography, electroplating, moulding) method, which have a non-magnetic behaviour.

However, the use of such materials, nickel-phosphorus, or similar, may prove to be sensitive in certain climatic conditions, which are likely to lead to a degradation of performances, particularly in terms of amplitude regularity, stoppages, or also ageing, especially when the two antagonistic components of the friction torque are produced in similar LIGA materials.

### SUMMARY OF THE INVENTION

The invention proposes to solve the technical problem of the resistance of the usual horological lubricant, and more particularly of guaranteeing an epilame effect, in usual climatic conditions, on components made of LIGA NiP12, or similar, non-ferromagnetic, in particular on Swiss lever escape wheels and pallets.

To this end, the invention relates to a method for manufacturing timepiece wheels according to claim 1.

### DETAILED DESCRIPTION OF PREFERRED EMBODIMENTS

The invention relates to the field of micromechanical components, and more particularly timepiece wheels.

The invention proposes to solve particularly the technical problem of the resistance of the usual horological lubricant, in usual climatic conditions, on components made of LIGA NiP12, or similar, non-ferromagnetic, in particular on wheels of a Swiss lever escapement mechanism.

In Swiss lever timepiece escapement mechanisms, the contact between the gathering-pallet made of ruby of the pallet and the tooth of the escape wheel is particularly sensitive, in the same way as the contact between the fork and the pallet-stone pin or between the fork and the pallet banking-pins.

In particular, this concerns ensuring the presence of lubricant on the contact surfaces between the escape wheel and the pallet, and reducing the ageing of the escape wheel and of the pallet.

The main problem is the loss of epilame effect on the plate of the escape wheel, which causes a spreading of the oil and a loss of lubrication at the contact between the tooth of the wheel and the gathering-pallet made of ruby.

The stability of the lubrication at the contact between the gathering-pallets of the pallet and the escape wheel must make it possible to guarantee the consistency of the amplitude.

To this end, the addition of a coating in the form of a layer of galvanic nickel (Ni) preferably, or of chemical nickel (for example NiP6-9), or also nickel-boron deposited chemically, on an escape wheel made of LIGA NiP12 makes it possible to substantially improve the performances of the movements.

Indeed, it has been demonstrated by various tests that this noteworthy improvement is related to a better resistance of the epilame in predetermined climatic conditions, for example at 50° Celsius and at a humidity level of 90%. A better adhesion of the epilame on the material has been observed by the inventors when the quantity of phosphorus on the surface is reduced, and consequently, the resistance of the lubricant is even better when the quantity of phosphorus is low.

In one variant, the coating of galvanic nickel may be an alloy, for example Ni—Fe, or Ni—W, or other.

Thus, the invention relates to a method for manufacturing a micromechanical component, particularly a timepiece wheel, according to which a substrate is produced with a first material including at least nickel and phosphorus, this substrate is shaped to the geometry of the wheel, and a coating of the substrate is performed, galvanically and/or chemically, on at least one surface of the substrate of the wheel, with at least one second material of low thickness, less than 10 micrometres, which constitutes a peripheral layer of the wheel at this at least one surface of the substrate of the wheel, and which includes at least nickel and which is poorer in phosphorus than the first material, or which includes nickel and is devoid of phosphorus.

More particularly, this first non-magnetic material is selected.

More particularly, this second non-magnetic material is selected. More specifically, it has a non-magnetic nature.

It is noted that nickel is not non-magnetic, and that NiP6-9% is not necessarily so, it is the low thickness of the deposit that gives the part its non-magnetic nature.

In a particular embodiment, the substrate is a nickel-phosphorus of formulation NiPx, with x between 1% and 15% by weight, or more particularly with x between 10% and 15% by weight, the latter range making it possible to guarantee the non-magnetic nature of the coating.

The coating covering the substrate is poor in phosphorus and its thickness is, but not limited to, between 0.2 micrometres and 10.0 micrometres, and, even more particularly between 0.2 micrometres and 2.0 micrometres.

Preferably, the coating has a thickness of 0.5 micrometres.

The coating treatment with a coating poor in phosphorus, according to the invention, may be carried out galvanically.

It is possible to apply a heat treatment to the substrate before the deposition operation, particularly galvanic, or, also to apply a heat treatment to the assembly formed by the substrate and its coating after the deposition operation, particularly galvanic.

It is also possible to apply a chemical treatment to the substrate to modify its surface features so as to facilitate the adhesion of the coating, particularly galvanically.

Alternatively, the coating treatment with a coating poor in or devoid of phosphorus, according to the invention may be carried out chemically, according to a method for applying chemical nickel, which may be pure nickel, or a nickel-phosphorus poor in phosphorus, for example NiP6-9, with 6% to 9% by weight of phosphorus, or also nickel-boron NiB.

The addition of a layer of nickel, or of NiP6-9, or of NiB, makes it possible to increase the stability of the epilame in all climatic conditions, the adhesion of the epilame and therefore the resistance of any usual horological lubricant.

More particularly, the epilame used is a formulation based on fluorine.

The lubricant may, also, be deposited on an escapement wheel with a complement in the form of a paste based on molybdenum disulphide MoS2, which acts as lubricant and lubricant sponge.

Advantageously, the escapement wheel concerned has a geometry making it possible to reduce to a minimum the contact surfaces, for example the use of a rounded-off pallet is preferred, which is a pallet the active faces of the fork of which, intended to come into contact with the plate pin and the banking-pins, are rounded, which makes it possible to have a contact point instead of a contact line.

An innovative embodiment of escapement mechanism includes a pallet made of LIGA, or a pallet of which at least the pallet-stones are made of LIGA. In such a case, the portions made of LIGA of the pallet are subjected to the same problem, and the same solution is applicable.

The invention makes it possible to guarantee normal ageing conditions, a consistency of the amplitude and the absence of stoppages, particularly in the presence of rounded-off LIGA nickel-phosphorus pallets, which ensure a better shock resistance than silicon pallets, for example.

Thus, in a preferred manner, a method for manufacturing a timepiece wheel is implemented, according to which:
a substrate is manufactured with a first material including at least nickel and phosphorus, and
a coating of this substrate is performed, on at least one surface of the substrate of the wheel, with at least one second material that constitutes a peripheral layer of the wheel at this at least one surface of the substrate;
this at least one second material includes at least nickel, and is poorer in phosphorus than the first material, or this at least one second material includes nickel and is devoid of phosphorus.

More particularly, this coating of the substrate is performed, on at least one surface adjoining a friction surface of the wheel, with this at least one second material, which constitutes a peripheral layer of the wheel at this at least one surface adjoining a friction surface. “Adjoining” means that the two surfaces are contiguous, or at least tangential, their intersection is not empty, even if it is limited to an isthmus of very small section.

More particularly, the substrate is shaped to the geometry of the wheel.

More particularly, this coating of the substrate is performed galvanically and/or chemically and/or by PVD and/or CVD.

In one variant, this coating of the substrate is performed on the surfaces of the wheel other than the guide surfaces of the wheel for its pivoting or for its guiding according to a single degree of freedom. More particularly, this coating of the substrate is performed on all of the surfaces of the wheel other than these guide surfaces of the wheel.

In another variant, this coating of the substrate is performed on the surfaces of the wheel including these guide surfaces of the wheel.

In yet another variant, this coating is performed on at least one surface adjoining a friction surface of the wheel, other than the guide surfaces of the wheel for its pivoting or for its guiding according to a single degree of freedom. More particularly, this coating of the substrate is performed on all of the surfaces of the wheel other than the guide surfaces of the wheel for its pivoting or for its guiding according to a single degree of freedom.

In yet another variant, the coating of the substrate is performed at the surfaces adjoining a friction surface of the wheel including the guide surfaces of the wheel for its pivoting or for its guiding according to a single degree of freedom.

In one variant, the coating of the substrate is performed on all of the surfaces of the wheel.

More particularly, the first material including phosphorus with a proportion by weight between 1% and 15% is selected.

More particularly, the first material only consisting of nickel and phosphorus is selected.

More particularly, the first non-magnetic material with a proportion by weight of phosphorus between 10% and 15% is selected.

More particularly, the first non-magnetic material is selected.

More particularly, the second material only including pure nickel, or only nickel and phosphorus is selected.

More particularly, the second material with a proportion by weight of phosphorus less than or equal to 15% is selected.

More particularly, the second non-magnetic material with a proportion by weight of phosphorus between 10% and 15% is selected.

In one alternative, the second material with a proportion by weight of phosphorus between 6% and 12% is selected.

In another alternative, the second material with a proportion by weight of phosphorus between 1% and 6% is selected.

In yet another alternative, the second material with a proportion by weight of phosphorus less than or equal to 1% is selected.

More particularly, the second material including boron is selected.

Even more particularly, the second material only consisting of nickel and boron is selected.

In one variant, the second material is applied galvanically.

In another variant, the second material is applied chemically.

More particularly, the coating with a thickness less than 10 micrometres is applied.

More particularly, the coating with a thickness between 0.2 micrometres and 5.0 micrometres is applied. Even more particularly, the coating with a thickness between 0.2 micrometres and 2.0 micrometres is applied.

In yet another variant, the coating with a thickness less than 0.2 micrometres, particularly in the vicinity of 0.1 micrometres is applied.

More particularly, a heat treatment is applied to the assembly formed by the substrate and its coating, at a temperature between 100° C. and 500° C., for 1 to 8 hours. In one alternative, this heat treatment is performed after the coating operation. In another alternative, this heat treatment is performed before the coating operation.

More particularly, the substrate is produced by a “LIGA” (Röntgenlithographie, Galvanoformung, Abformung, meaning lithography, electroplating, moulding) method.

More particularly, a coating is performed galvanically and/or chemically on all of the surfaces of the substrate, with such a second material.

More particularly, this method for manufacturing an escapement wheel formed for example by an escape wheel or a pallet is applied.

In one variant, the thickness of the second material that constitutes the peripheral layer of the wheel at the at least one surface adjoining a friction surface is limited to less than 10 micrometres. Even more particularly, the thickness of the second material that constitutes the peripheral layer of the wheel at the at least one surface adjoining a friction surface is limited to less than 5 micrometres.

In one variant, the thickness of the second material that constitutes the peripheral layer of the wheel at the at least one surface of the substrate is limited to less than 10 micrometres. Even more particularly, the thickness of the second material that constitutes the peripheral layer of the wheel at the at least one surface of the substrate is limited to less than 5 micrometres.

This method makes it possible to produce a micromechanical component, particularly a timepiece wheel, and even more particularly an escapement mechanism wheel, the surface of which is optimised.

The wheel thus manufactured may advantageously receive, on its friction surfaces, a lubricating substance, for example an oil or a synthetic grease adapted to precision micro-engineering applications, known by the person skilled in the art of horology. Such a lubricating substance may be combined with a paste based on molybdenum disulphide MoS2.

The wheel may also advantageously receive an epilame layer on at least one surface of the coating other than its friction surfaces in order to make possible a better resistance of the lubricating substance.

1-26. (canceled)

27. A method for manufacturing a timepiece wheel, the method comprising
manufacturing a substrate with a first material including at least nickel and phosphorus; and
coating said substrate, on at least one surface of the substrate of said wheel, with at least one second material that constitutes a peripheral layer of said wheel at said at least one surface of the substrate of said wheel, and which includes at least nickel and which is poorer in phosphorus than said first material, or which includes nickel and is devoid of phosphorus.

28. The method according to claim 27, wherein said coating of said substrate is performed, on at least one surface adjoining a friction surface of said wheel, with said at least one second material that constitutes the peripheral layer of said wheel at said at least one surface adjoining a friction surface of said wheel.

29. The method according to claim 27, wherein said substrate is shaped to the geometry of said wheel.

30. The method according to claim 27, wherein said coating of said substrate is performed by at least one of galvanically, chemically, by PVD, and by CVD.

31. The method according to claim 27, wherein said first material only consisting of nickel and phosphorus is selected.

32. The method according to claim 27, wherein said first material with a proportion by weight of phosphorus between 1% and 15% is selected.

33. The method according to claim 27, wherein said first non-magnetic material with a proportion by weight of phosphorus between 10% and 15% is selected.

34. The method according to claim 27, wherein said second material only including pure nickel, or only nickel and phosphorus, is selected.

35. The method according to claim 27, wherein said second material with a proportion by weight of phosphorus less than or equal to 15% is selected.

36. The method according to claim 35, wherein said second material with a proportion by weight of phosphorus between 6% and 12% is selected.

37. The method according to claim 35, wherein said second material with a proportion by weight of phosphorus between 1% and 6% is selected.

38. The method according to claim 35, wherein said second material with a proportion by weight of phosphorus less than or equal to 1% is selected.

39. The method according to claim 27, wherein said second material including boron is selected.

40. The method according to claim 27, wherein said second material only consisting of nickel and boron is selected.

41. The method according to claim 27, wherein said second non-magnetic material with a proportion by weight of phosphorus between 10% and 15% is selected.

42. The method according to claim 27, wherein said second material with a thickness less than 10 micrometres is applied.

43. The method according to claim 42, wherein said second material with a thickness less than 5 micrometres is applied.

44. The method according to claim 43, wherein said second material with a thickness between 0.2 micrometres and 5.0 micrometres is applied.

45. The method according to claim 44, wherein said second material with a thickness between 0.2 micrometres and 2.0 micrometres is applied.

46. The method according to claim 27, further comprising applying a heat treatment to the assembly formed by said substrate and said coating, at a temperature between 100° C. and 500° C., for 1 to 8 hours.

47. The method according to claim 46, wherein said heat treatment is performed after the coating operation.

48. The method according to claim 46, wherein said heat treatment is performed before the coating operation.

49. The method according to claim 27, wherein said second substrate is produced by a “LIGA” method.

50. The method according to claim 27, wherein said method is applied to the manufacturing of an escapement wheel that is an escape wheel or a pallet.

51. The method according to claim 28, wherein the thickness of said second material that constitutes the peripheral layer of said wheel at said at least one surface adjoining a friction surface is limited to less than 10 micrometres.

52. The method according to claim 51, wherein the thickness of said second material that constitutes the peripheral layer of said wheel at said at least one surface adjoining a friction surface is limited to less than 5 micrometres.
